(19) United States
(12) Patent Application Publication
(10) Pub. No.: US 2024/0425139 A1
(43) Pub. Date: Dec. 26, 2024

(54) COMBINATIVE BICYCLE PEDAL

(71) Applicant: Chin-Long Hsieh, Taichung City (TW)

(72) Inventor: Chin-Long Hsieh, Taichung City (TW)

(21) Appl. No.: 18/220,280

(22) Filed: Jul. 11, 2023

(30) Foreign Application Priority Data
Jun. 20, 2023 (TW) 112123110

(51) Int. Cl. B62M 3/08

(52) U.S. Cl. CPC B62M 3/08

(57) ABSTRACT

A bicycle pedal includes a shaft body and a pedal body. The shaft body includes a shaft rod and an insert plate. The shaft rod is rotatably disposed in the insert plate with exposing a threaded head. The pedal body is disposed with an inserting hole corresponding to a shape of the insert plate for being inserted by the insert plate.

### BACKGROUND

### Technical Field

The invention relates to bicycles, particularly to bicycle pedals.

### Related Art

A bicycle pedal is composed of a shaft and a pedal body. The shaft is inserted and rotatably disposed in the pedal body. The pedal body is an integral body and the combination of the shaft and the pedal body does not allow to be disassembled or repaired by users. For manufactures, both the shaft and the pedal body are an unvarying combination, so they lack combinative flexibility and the combination of the shaft and the pedal body cannot be arbitrarily changed depending on the requirements and variations of the market, for example, a single shaft is mated with pedal bodies with different materials, colors or shapes. For users, besides the limitation of being unable to change material, color or shape of the pedal body, neither of the peal body and the shaft can be independently replaced when one of the both fails. This increases the maintenance costs.

### SUMMARY

An object of the invention is to provide a combinative bicycle pedal, whose pedal body and shaft rod adopt a simplified combination. The both can be freely combined and either of the both can be independently replaced to reduce maintenance costs when it fails.

To accomplish the above object, the combinative bicycle pedal of the invention includes a shaft body and a pedal body. The shaft body includes a shaft rod and an insert plate. The shaft rod is rotatably disposed in the insert plate with exposing a threaded head. The pedal body is disposed with an inserting hole corresponding to a shape of the insert plate for being inserted by the insert plate.

### BRIEF DESCRIPTION OF THE DRAWINGS

FIG. 1 is an exploded view of the first embodiment of the disclosure;

FIG. 2 is an assembled view of the first embodiment of the disclosure;

FIG. 3 is an assembled top view of the first embodiment of the disclosure;

FIG. 4 is a cross-sectional view of the first embodiment of the disclosure along long line 4-4 in FIG. 3;

FIG. 5 is a cross-sectional view of the first embodiment of the disclosure along long line 5-5 in FIG. 3;

FIG. 6 is an exploded view of the second embodiment of the disclosure;

FIG. 7 is an assembled view of the second embodiment of the disclosure; and

FIG. 8 is a schematic view of an additional application of the first embodiment of the disclosure.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

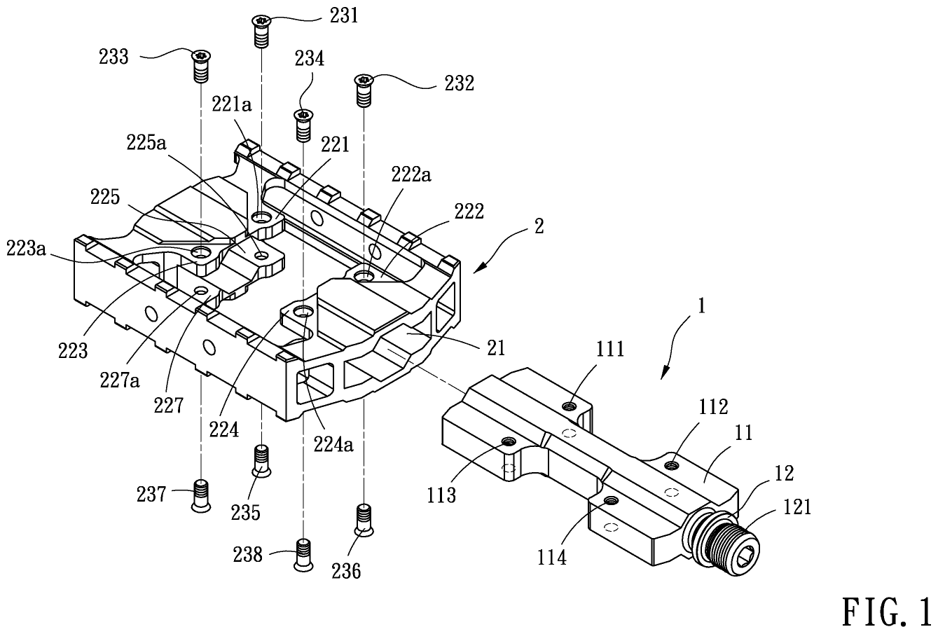

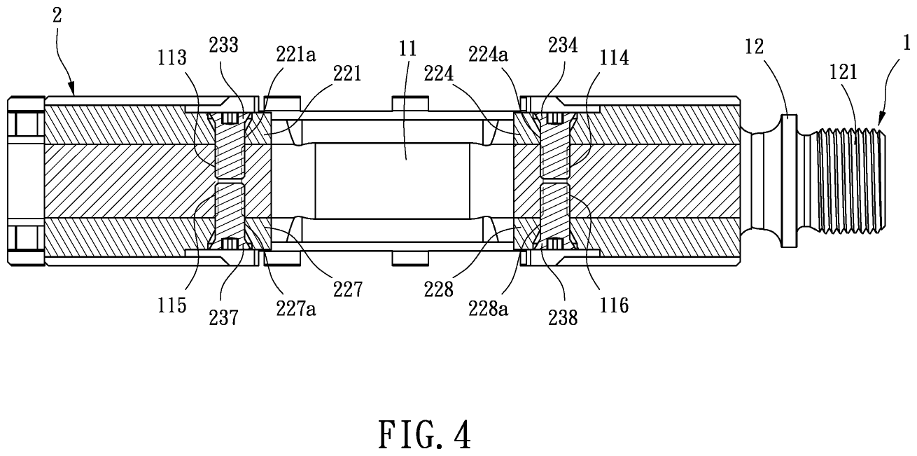

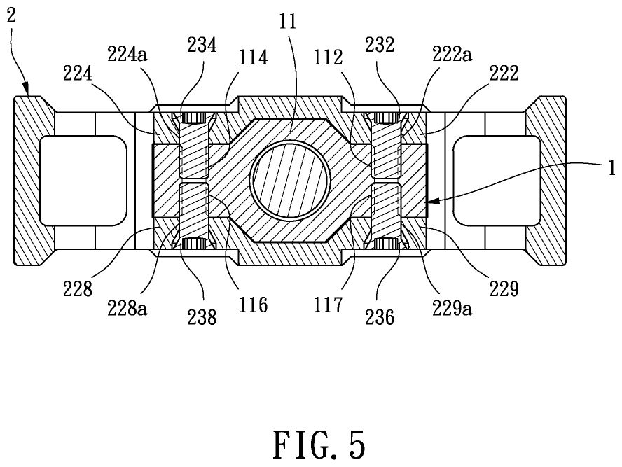

Please refer to FIGS. 1-5, which show the first embodiment of the invention. The invention provides a combinative bicycle pedal, which includes a shaft body 1 and a pedal body 2. The shaft body 1 includes a shaft rod 12 and an insert plate 11. The shaft rod 12 is rotatably disposed in the insert plate 11 with exposing a threaded head 121 which is used to connect with a crank (not shown). The insert plate 11 can rotate about the shaft rod 12. The inset plate 11 is of a substantial H-shape.

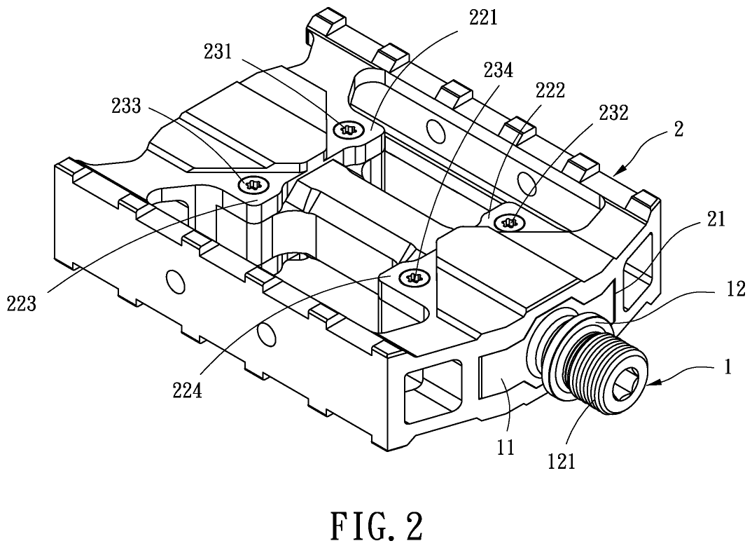

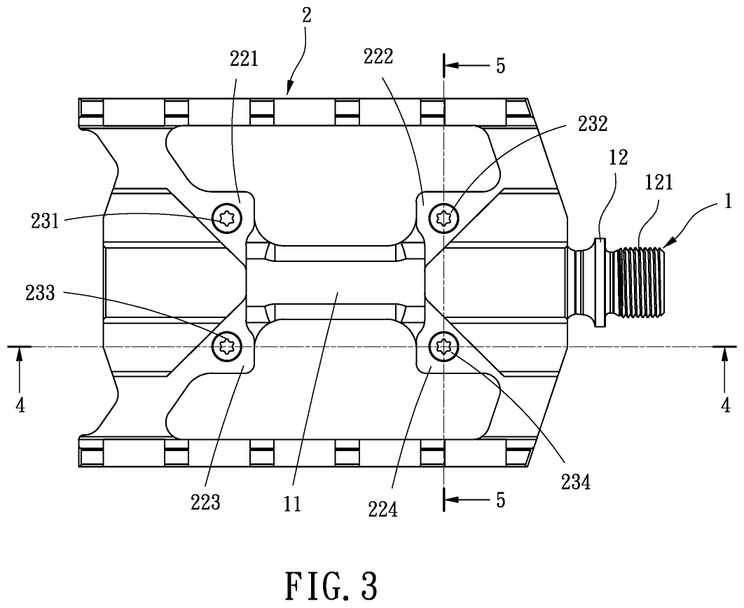

The pedal body 2 is a substantially rectangular plate, which can be formed into any required shapes such as hexagon. The pedal body 2 is disposed with an inserting hole 21. The inserting hole 21 corresponds to the length, width and height of the insert plate 11 to be inserted by the insert plate 11. After the insert plate 11 is inserted into the inserting hole 21, an outer end of the insert plate 11 is flush with an end of the pedal body 2 to form a complete pedal as shown in FIGS. 2 and 3.

Each of two stepping sides of the pedal body 2 is disposed with four sheets 221, 222, 223, 224, 225, 227. The four sheets 221, 222, 223, 224 on the same stepping side are symmetrically distributed on two sides of the axis of the pedal body 2 and are completely symmetrical to the four sheets 225, 227 on the other stepping side. Each sheet 221, 222, 223, 224, 225, 227 is formed with a through hole 221a, 222a, 223a, 224a, 225a, 227a, 228a, 229a. Each through hole 221a, 222a, 223a, 224a, 225a, 227a, 228a, 229a can be passed by a screw 231-238.

Each of two opposite sides of the insert plate 11 is formed with four threaded holes 111-117. Each threaded hole 111-117 separately corresponds to one of the through holes 221a, 222a, 223a, 224a, 225a, 227a, 228a, 229a. Each threaded hole 111-117 can be screwed by a screw 231-238. When the insert plate 11 is completely inserted into the inserting hole 21, each through hole 221a, 222a, 223a, 224a, 225a, 227a, 228a, 229a is aligned with one of the threaded holes 111-117. At this time, a screw 231-238 can pass the through hole 221a, 222a, 223a, 224a, 225a, 227a, 228a, 229a and then is screwed into corresponding one of the threaded holes 111-117 so as to fix the pedal body 2 and the shaft body 1 to be integral to form a complete pedal.

According to the above structure, manufacturers can use a single shaft body 1 to mate with different pedal bodies 2 which have different materials, shapes or colors so as to increase manufacturing flexibility. Also, for users, when the pedal body 2 or the shaft body 1 fails, it can be independently replaced to reduce the maintenance costs.

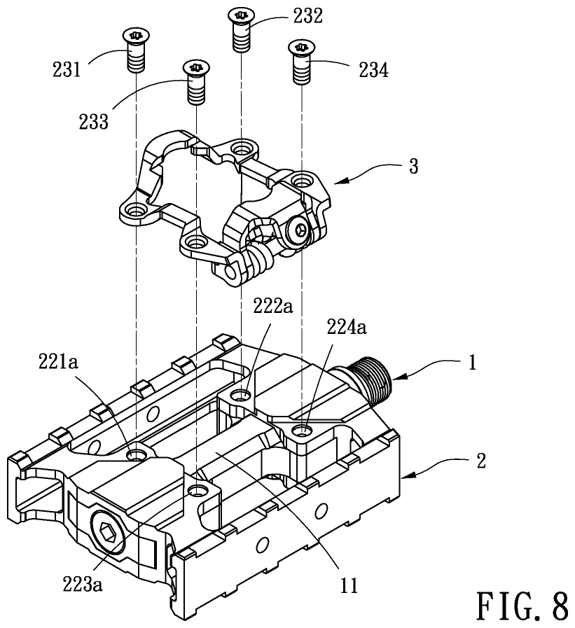

In addition, the arrangement of the through holes 221a, 222a, 223a, 224a, 225a, 227a, 228a, 229a and the threaded holes 111-117 may also allow a cleat fastener 3 to be fixed by the screws 231-238. The cleat fastener 3 is used to fasten a cleat (not shown) fixed on a sole of a cycling shoe to form a clipless pedal as shown in FIG. 8.

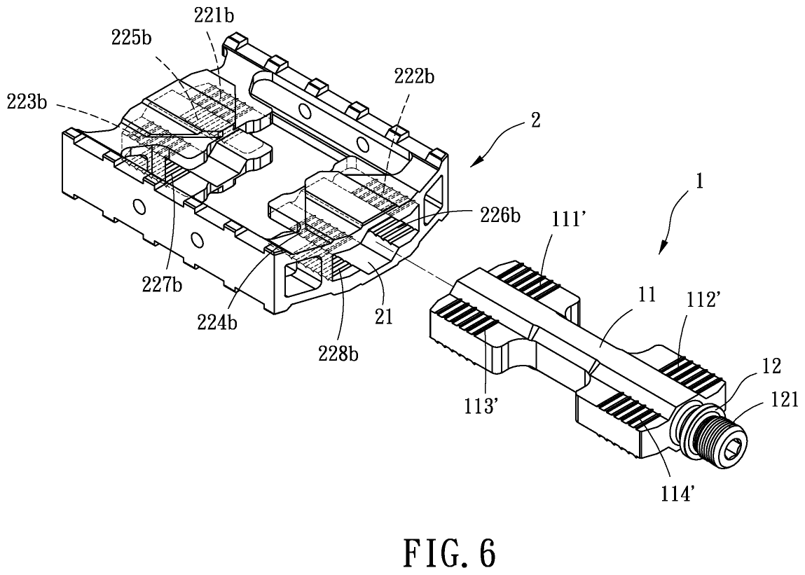

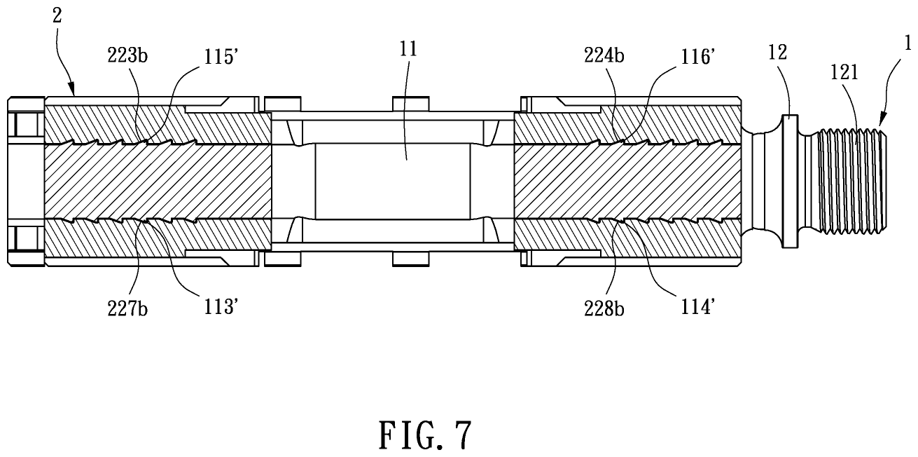

Please refer to FIGS. 6 and 7, which show the second embodiment of the invention. The embodiment is substantially the same as the first embodiment. The difference therebetween is that this embodiment uses engagement of inverted hooks to replace the fixture of the screws 231-238 and the threaded holes 111-117. In detail, each of two opposite sides of the insert plate 11 is disposed with four rows of inverted hooks 111′-117′. The arranging direction of each row of inverted hooks 111′-117′ is parallel to the shaft rod 12. An inner surface of the inserting hole 21 is disposed with four rows of indented hooks 221b-228b separately corresponding to the four rows of inverted hooks 111′-117′. The inverted hooks 111′-117′ match with the indented hooks 221b-228b in shape to be engageable with each other. The engaging direction of the inverted hooks 111′-117′ and the indented hooks 221b-228b is unidirectional. It only allow a single direction to be inserted and does not allow withdrawal. Complete insertion completes the fixture without using screws.

While this disclosure has been described by means of specific embodiments, numerous modifications and variations could be made thereto by those skilled in the art without departing from the scope and spirit of this disclosure set forth in the claims.

What is claimed is:

1. A combinative bicycle pedal comprising:
a shaft body, comprising a shaft rod and an insert plate, and the shaft rod being rotatably disposed in the insert plate with exposing a threaded head; and
a pedal body, disposed with an inserting hole corresponding to a shape of the insert plate for being inserted by the insert plate.

2. The combinative bicycle pedal of claim 1, wherein each of two opposite sides of the insert plate is formed with four threaded holes, the pedal body is formed with multiple through holes separately corresponding to each of the through holes, each through hole is passed by a screw, and the screw is screwed into corresponding one of the threaded holes.

3. The combinative bicycle pedal of claim 1, wherein the insert plate is of a substantial H-shape.

4. The combinative bicycle pedal of claim 1, wherein an outer end of the insert plate is flush with an end of the pedal body.

5. The combinative bicycle pedal of claim 2, wherein each of two stepping sides of the pedal body is disposed with four sheets, and the four sheets on the same stepping side are symmetrically distributed on two sides of an axis of the pedal body.

6. The combinative bicycle pedal of claim 1, wherein each of two opposite sides of the insert plate is disposed with four rows of inverted hooks, an inner surface of the inserting hole is disposed with four rows of indented hooks separately corresponding to the four rows of inverted hooks, and the inverted hooks match with the indented hooks in shape to be engageable with each other.

7. The combinative bicycle pedal of claim 6, wherein an arranging direction of each row of inverted hooks is parallel to the shaft rod.

8. The combinative bicycle pedal of claim 1, wherein an engaging direction of the inverted hooks and the indented hooks is unidirectional.
